(19) United States
(12) Patent Application Publication
(10) Pub. No.: US 2009/0267406 A1
(43) Pub. Date: Oct. 29, 2009

(54) BRAKE ASSEMBLIES AND ACTUATORS

(75) Inventor: Robert William Thompson, Farnborough (GB)

Correspondence Address: OLIFF & BERRIDGE, PLC, P.O. BOX 320850, ALEXANDRIA, VA, 22320-4850, US

(73) Assignee: QINETIQ LIMITED, London (UK)

(21) Appl. No.: 12/440,731

(22) PCT Filed: Sep. 26, 2007
(86) PCT No.: PCT/GB2007/003634

§ 371 Date: Mar. 11, 2009

(30) Foreign Application Priority Data
Oct. 18, 2006 (GB) 0620577.7

(51) Int. Cl. B62D 55/00; F16D 65/14

(52) U.S. Cl. 305/120; 188/72.2

(57) ABSTRACT

A self-energising brake assembly, particularly for braking a drive shaft of a heavy tracked vehicle such as a tank, has a pair of discs carrying friction pads borne to rotate with the shaft. These friction discs are located to either side of a central non-rotating water-cooled disc assembly. A control brake disc is also borne to rotate with the shaft but capable of turning relative to the same via a ball screw assembly. To apply the brake the control disc is retarded relative to the shaft by means of an associated caliper, which causes relative axial movement between the inner and outer rings of the ball screw. This movement drives the friction disc axially along the shaft, on a ball spline, towards the friction disc, thus clamping the non-rotating disc between the two friction discs and braking the shaft.

The present invention relates to brake assemblies and more particularly to disc brakes incorporating a novel form of actuator for applying the brake. Assemblies according to the invention may be found useful for braking axles, shafts, wheels or the like in a variety of vehicular applications or in other machinery, including dynamometers, but particularly for heavy vehicles such as armoured military vehicles or large goods vehicles. One application comprises the brakes in a drive configuration for a battle tank, bulldozer or other skid steered vehicle as described in WO-02/083483 or WO-2006/021745.

Conventional braking systems for heavy vehicles as exemplified above typically involve complex, expensive, heavy and bulky hydraulic or pneumatic power sources and actuators in order to apply the brakes. In one aspect the invention seeks to provide brake assemblies suitable for such vehicles which are self-energising in the sense that the source of power under which the brakes are applied is effectively derived form the movement of the vehicle itself.

Accordingly, in one aspect the invention resides in a brake assembly for a rotatable member comprising: a rotary disc member borne by said rotatable member to rotate with the same but capable of moving axially relative to the same into frictional contact with an associated non-rotatable disc member to brake said rotatable member; a control brake member borne by said rotatable member to rotate with the same but capable of turning relative to the same; a screw assembly between said control brake member and said rotary disc member; and means for selectively retarding the rotation of said control brake member relative to said rotatable member whereby to cause said screw assembly to shift said rotary disc member axially into said frictional contact with said non-rotatable disc member.

In a vehicular application, for example, the rotatable member to be braked may be a wheel hub, drive shaft or other transmission or bearing element which, at the time of brake application, is rotating under the momentum of the moving vehicle, and transmits the power to brake the vehicle once the control brake has been retarded, thereby avoiding the need for the conventional hydraulic or pneumatic servo-assisted braking system in the case of a heavy vehicle as exemplified above. In practice the force required to retard the control brake member in such an assembly should be only a fraction of the force required to apply the (main) brake.

The aforesaid rotary disc member may be arranged to carry brake friction material for contact with the non-rotatable disc member, or vice versa.

There may be a second rotary disc member borne by said rotatable member to rotate with the same and disposed on the opposite side of said non-rotatable disc member to the first-mentioned rotary disc member, whereby axial movement of the first-mentioned rotary disc member is effective to clamp the non-rotatable disc member between the two rotary disc members.

The non-rotatable disc member may be adapted to be cooled by the circulation of liquid through an internal chamber thereof, and in this respect is preferably a disc as described in PCT/GB2007/001037.

The aforesaid screw assembly is preferably a high efficiency screw assembly such as a ball screw assembly (which can typically achieve 98% efficiency) or a planetary screw assembly.

In particular the screw assembly may comprise radially inner and outer screw rings with a plurality of balls therebetween, one of said rings being arranged to rotate with said rotatable member but capable of moving axially relative thereto, and the other of said rings being arranged to rotate with said control brake member but capable of moving axially relative thereto.

The screw assembly may be abutted between a pair of thrust bearings, a first such bearing being borne by said rotatable member to rotate with the same without freedom to move axially relative to the same, and the second such bearing being abutted between the screw assembly and the first-mentioned rotary disc member and serving to transmit axial movement from the screw assembly to such disc member.

The aforesaid control brake member may be in the form of a disc or drum which is retarded, when the (main) brake is to be applied, by means of a conventional calliper, shoe(s) or other friction material-bearing means.

In another aspect the invention resides in a rotary-to-linear actuator comprising: first and second members borne for relative rotational movement therebetween over a certain range in opposite senses from a central position; a screw assembly comprising outer and inner threaded members; said outer threaded member being rotationally located with respect to said first member but capable of moving axially relative thereto; said inner threaded member being rotationally located with respect to said second member but capable of moving axially relative thereto; and abutment means at one axial end of said screw assembly which are axially located with respect to said first and second members; all constructed and arranged such that: relative rotational movement between said first and second members in one sense away from said central position causes said outer threaded member to be in abutment with said abutment means while said inner threaded member is driven axially away from said abutment means in a predetermined sense; and relative rotational movement between said first and second members in the other sense away from said central position causes said inner threaded member to be in abutment with said abutment means while said outer threaded member is driven axially away from said abutment means in the same said predetermined sense.

For the avoidance of doubt, as used herein, and particularly in the appended claims, the term “disc” does not necessarily imply a complete body of revolution but, where the context so admits, may also include a structure in the form of one or more sectors.

These and other aspects of the present invention will now be more particularly described, by way of example, with reference to the accompanying drawings in which:—

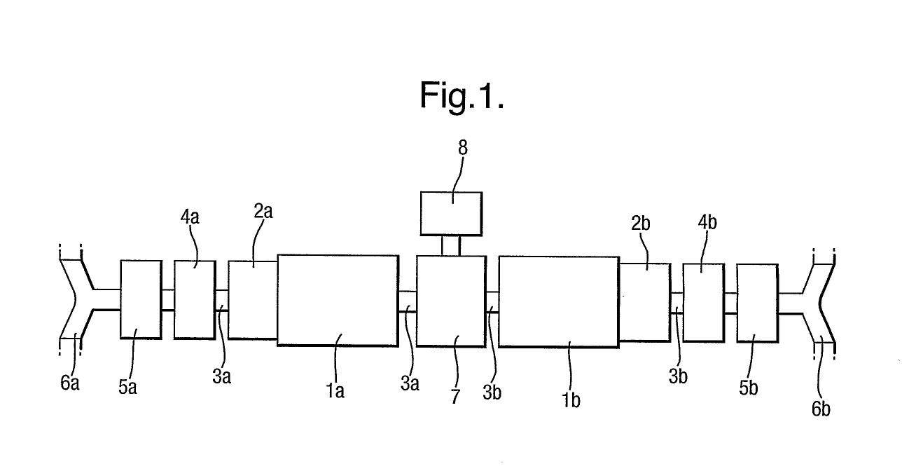

FIG. 1 is a diagrammatic illustration of a drive configuration for a skid steered vehicle in which brake assemblies according to the invention may be used;

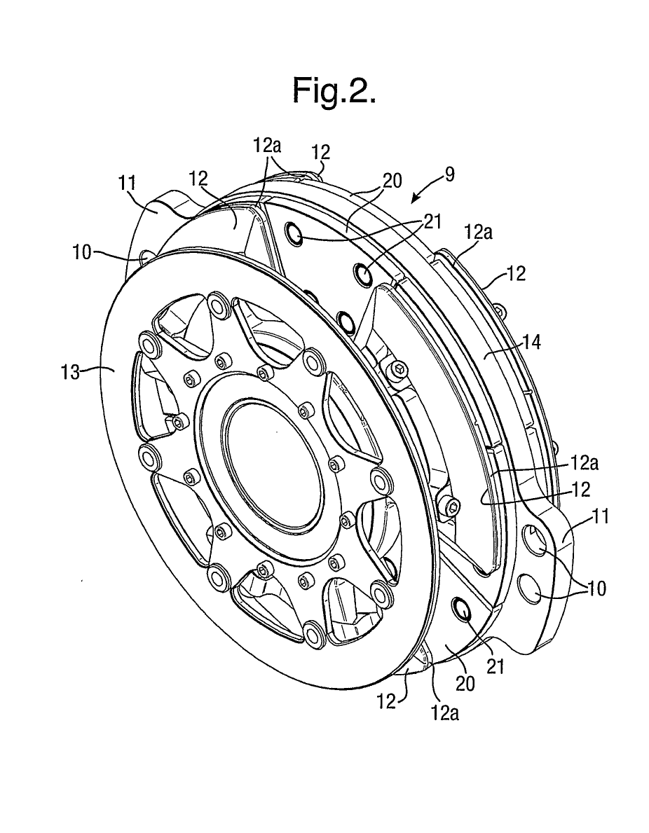

FIG. 2 is a pictorial view of one embodiment of a brake assembly according to the invention;

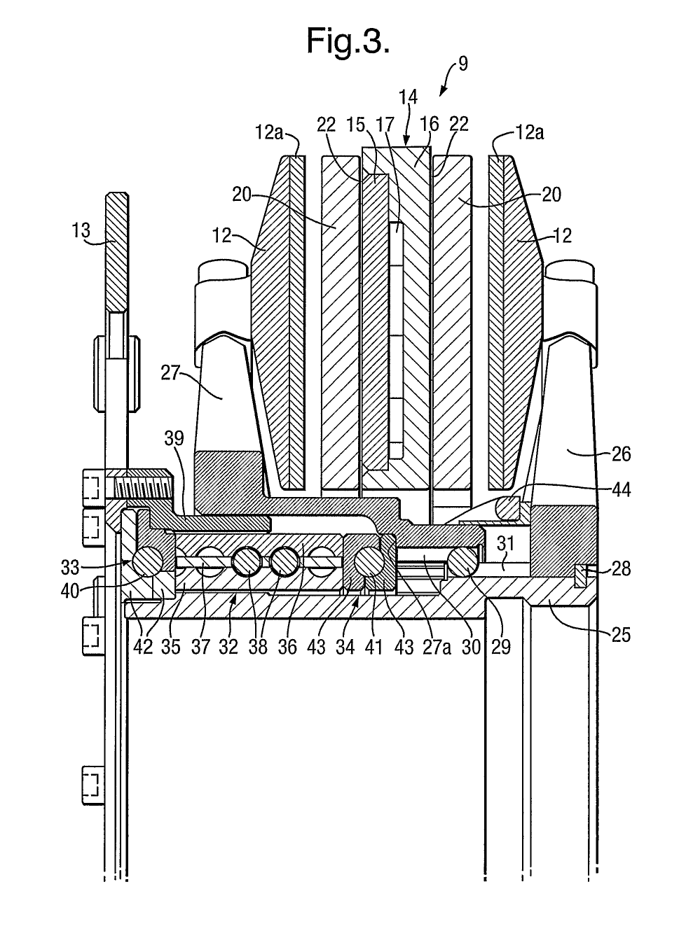

FIG. 3 is an axial half section of the assembly of FIG. 2 in the brake-released condition;

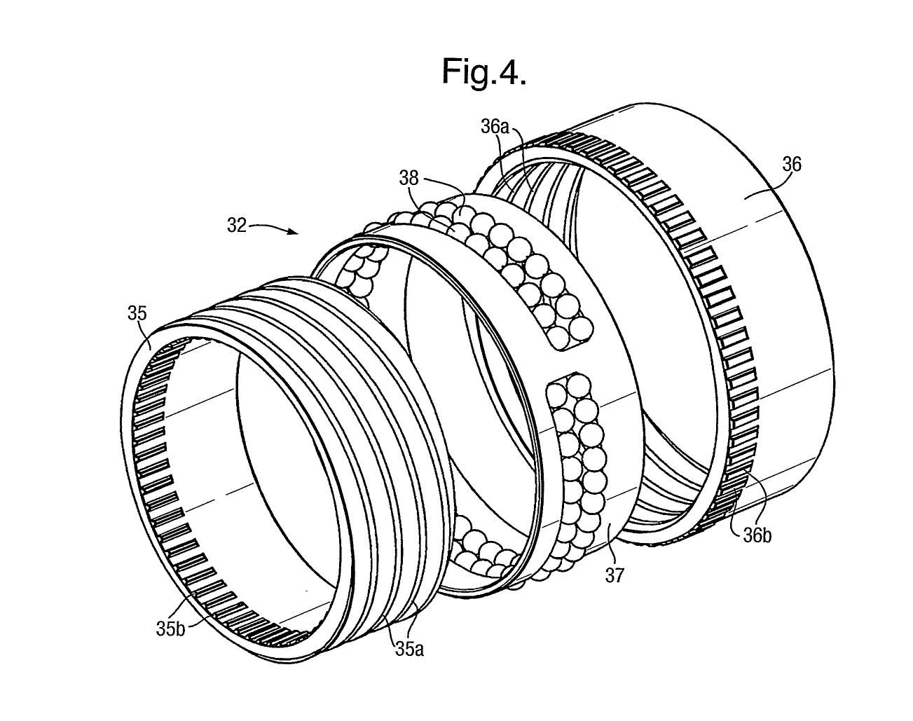

FIG. 4 is an “exploded” pictorial view of the ball screw assembly comprised in the brake assembly of FIGS. 2 and 3; and

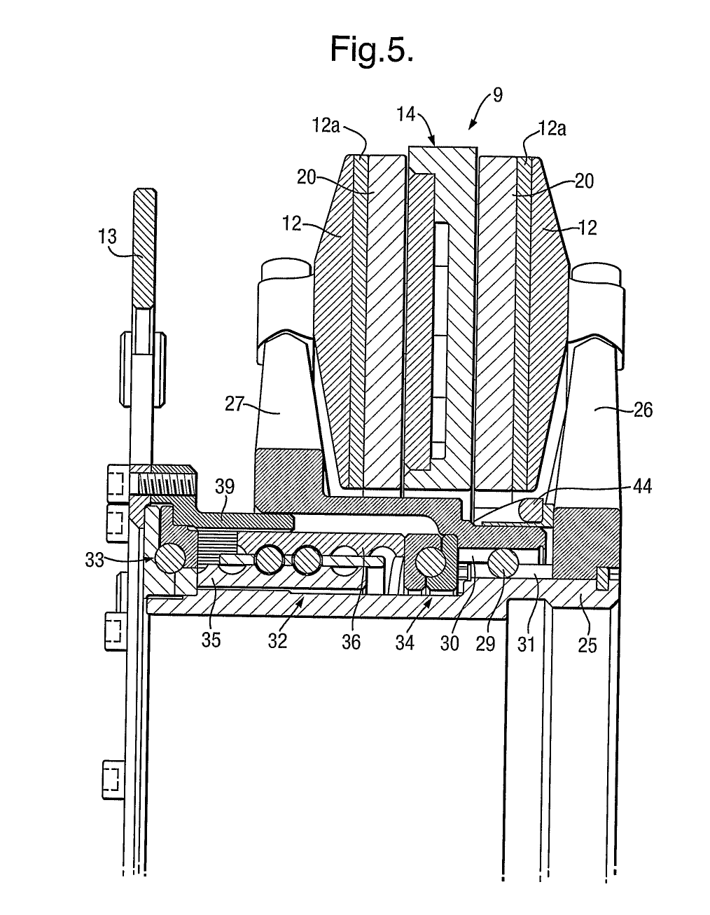

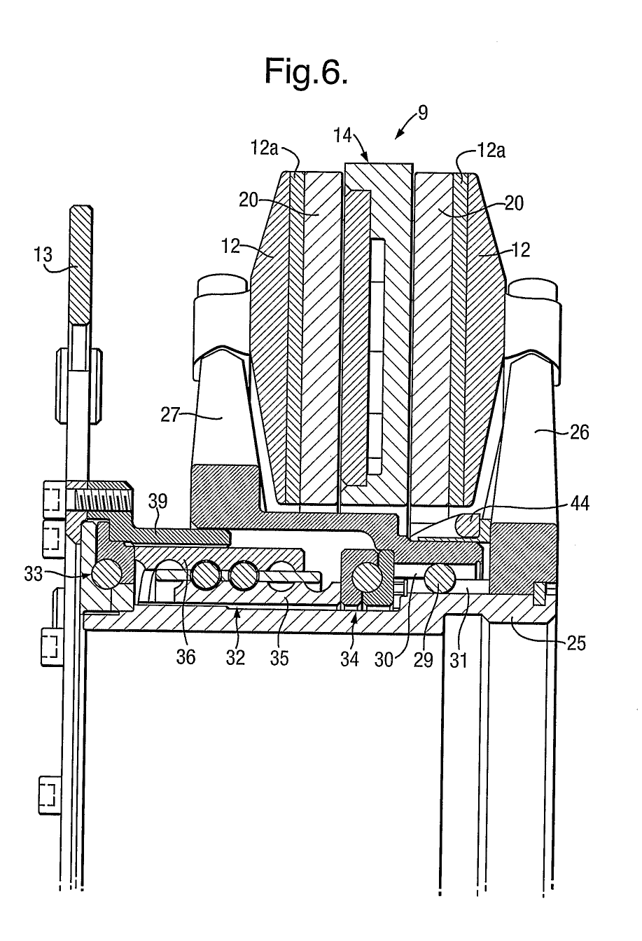

FIGS. 5 and 6 are views similar to FIG. 2 of the brake assembly in brake-applied conditions respectively during forward and reverse movement of a vehicle in which the assembly is incorporated.

Referring to FIG. 1, this illustrates diagrammatically one form of drive configuration with which brake assemblies in accordance with the present invention may be found particularly useful, being a track drive arrangement for a skid steered vehicle according to WO-02/083483 or WO-2006/021745. It is to be understood, however, that the present invention is more generally applicable to the braking of axles, shafts, wheels or the like in both vehicular and non-vehicular applications.

In FIG. 1 a transverse drive arrangement comprises two electric propulsion motors 1a and 1b with associated gear change units 2a and 2b turning drive shafts 3a and 3b. Outboard of these units the transmission includes in each case a brake 4a, 4b and final drive gear reduction 5a, 5b, all encased within the vehicle hull, leading to respective track drive sprockets 6a and 6b at opposite sides of the vehicle. Inboard the drive shafts 3a and 3b are coupled to a controlled differential 7 driven by an electric steer motor 8 for steering control of the vehicle as described in WO-02/083483 and WO-2006/021745.

FIG. 2 illustrates an embodiment of an assembly according to the present invention for braking a rotatable shaft (itself not seen in the Figure). In the context of FIG. 1, therefore, an assembly of this kind would be used on each side of the transmission as the brake 4a, 4b acting on the respective drive shaft 3a, 3b. It comprises a central compound liquid-cooled brake disc 9 of the kind described in PCT/GB2007/001037, which surrounds the shaft to be braked with clearance and which is essentially stationary (relative to the vehicle) in use—being mounted on fixed pins (not shown) extending through holes 10 in external flanges 11 of the disc so as to be non-rotatable but with a slight axial float. Disposed to either side of the stationary disc are a pair of rotary discs, each splined onto the shaft to turn with the same and carrying respective sets of pads 12 covered with conventional friction material 12a adjacent to the opposite major faces of the disc 9. The pads 12 as shown are in the form of discrete sectors but could alternatively be in the form of complete discs. When the brake is applied, an actuator to be more particularly described below, and including a control brake disc 13, forces one of the discs carrying pads 12 axially towards the other along the shaft, thus clamping the fixed disc 9 between them and braking the shaft by virtue of the frictional contact between the material 12a and the confronting surfaces of the disc 9.

Referring now more particularly to FIG. 3, the stationary disc 9 comprises a central annular cooling plate 14 composed of two aluminium discs 15 and 16 which define between them an internal chamber 17 for the circulation of liquid coolant (e.g. water). The coolant is circulated by a pump (not shown) through a closed circuit including a radiator or other heat exchanger through which heat absorbed by the coolant from the disc 9 is given up. To each side of the plate 14 this disc comprises an assembly of cast iron sectors 20 which collectively define the opposite outer surfaces of the disc for contact by the friction material 12a of the pads 12. Each sector 20 is mounted on pins 21 (FIG. 2) projecting from the respective disc 15 or 16 with clearance between each pin and sector and between each sector and its neighbours, to allow for thermal expansion of the sectors without cracking. Associated shims, or merely surface roughness of the components, set a small air gap 22 in the region of 0.1 mm between each set of sectors 20 and the plate 14. The design of this disc is such as to provide that the energy from an individual braking event is first stored as a rise in temperature of the cast iron sectors 20 and then removed over a longer period by steady transfer through the plate 14 to the liquid coolant. The rate of heat transfer from the sectors 20 to the plate 14 is effectively determined by the intervening air gaps 22, the thermal conductances of which are lower than those of the metal components which they separate. In particular the thickness of the gaps 22 is set to ensure that boiling of the bulk of the liquid within chamber 17 is avoided.

With further reference to FIG. 3, a hub 25 is splined on the shaft to be braked and carries the two discs 26 and 27 which carry the friction pads 12. The right hand (as viewed) disc 26 is keyed on the hub 25 as at 28 so as to be located both rotationally and axially with respect to the hub. The left hand (as viewed) disc 27 is however located on the hub 25 through a ball spline comprising a ball 29 running in axial keyways 30, 31 in the disc and hub respectively (or a plurality of such ball splines spaced circumferentially around the hub) so as to turn with the hub but with freedom to move axially over a limited distance with respect to the hub.

Also carried by the hub are a ball screw assembly 32 and a pair of thrust bearings 33, 34. The components of the ball screw assembly are also seen in FIG. 4 and comprise an inner (male) screw ring 35 with external threads 35a and an outer (female) screw ring 36 with internal threads 36a, and a ball cage 37 therebetween.

In the illustrated embodiment the ball screw comprises two complete circuits of balls 38 in the cage 37 with a double start configuration and a large pitch so that relative rotation between the screw rings 35 and 36 of only about one quarter of a turn in either direction achieves full relative axial displacement of the rings in corresponding directions from the central position shown in FIG. 3. The inner screw ring 35 has splines 35b by which it is splined to the hub 25 and the outer screw ring 36 has splines 36b by which it is splined to a hub component 39 of the control brake disc 13. Subject to its connection through the ball screw assembly 32, the control brake disc can turn relative to the hub 25.

The thrust bearings 33 and 34 comprise respective sets of balls 40, 41 and races 42, 43. The left hand (as viewed) such bearing 33 is keyed on the hub 25 so as to be located both rotationally and axially with respect to the hub, while the right hand (as viewed) such bearing 34 is free to move axially over a limited distance with respect to the hub 25. The ball screw assembly 32 is in axial abutment between the thrust bearings 33 and 34 and the thrust bearing 34 is in axial abutment between the ball screw assembly and a shoulder 27a of the disc 27. A wave spring 44 trapped between the discs 26 and 27 exerts an axial force urging the disc 27 to the left (as viewed) so that in the normal brake-released condition of the assembly shown in FIG. 3 the friction pads 12 are held out of contact with the stationary disc 9 and the ball screw assembly 32 is held in its central position.

With the brake released and the vehicle in motion, the hub 25, ball screw 32, bearings 40, 41, friction discs 26, 27 and control brake disc 13 all rotate together with the respective drive shaft. To apply the brake a conventional calliper (not shown) is actuated to grip the control disc 13 so that that disc—and the outer ball screw ring 36 to which it is splined—is retarded relative to the remainder of the rotating assembly. The consequent relative angular displacement between the screw ring 36 and the screw ring 35 causes corresponding relative axial displacement between those components. The direction of these relative movements will depend on the direction (forwards or backwards) in which the vehicle is moving and the corresponding sense of rotation of the drive shaft, but let it be supposed that in the forward direction the consequent axial displacement is to urge the outer ring 36 to the right (as viewed) and to urge the inner ring 35 to the left (as viewed). Since leftward movement of the ring 35 is precluded by its abutment with the thrust bearing 33, however, the relative axial displacement of the rings is manifested by rightward movement of the outer ring 36, as shown in FIG. 5. The ring 36 consequently drives the disc 27 to the right through the agency of the thrust bearing 34, thereby clamping the “stationary” brake disc 9 between the two sets of friction pads 12 and braking the vehicle, the axial float of the disc 9 being sufficient to take up the gap between itself and the friction pads of the disc 26 under the axial force of the pads of disc 27.

If the brake is applied with the vehicle moving in the reverse direction, the consequent relative axial displacement between the ball screw rings is to urge the outer ring 36 to the left (as viewed) and to urge the inner ring 35 to the right (as viewed). In these circumstances, since leftward movement of the ring 36 is precluded by its abutment with the thrust bearing 33, the relative axial displacement is manifested by rightward movement of the inner ring 35 against the thrust bearing 34 as shown in FIG. 6, which consequently shifts the disc 27 to cause braking of the vehicle in the same way as described above.

So long as the control brake disc 13 remains gripped by its calliper after any application of the brake this will keep the assembly in the brake-applied condition of FIG. 5 or 6. Releasing that disc, however, permits the assembly to be returned to the brake-released condition of FIG. 3, by the force of the spring 44 acting against the disc 27 and through the thrust bearing 34 to the displaced ball screw ring 35 or 36. Return axial displacement within the ball screw assembly is of course accompanied by return angular displacement of the ring 36 and disc 13.

Additional springs may be provided to return the “stationary” disc 9 to its central position illustrated in FIG. 3 between successive brake actuations. Otherwise it may remain adjacent to the axially fixed friction disc 26 but without significantly retarding the vehicle without pressure applied from the shiftable disc 27.

It will be appreciated that in operation of the assembly described above with reference to the accompanying drawings the torque applied to the ball screw 32 is the torque applied at the control brake 13. The force generated by the ball screw, and so the braking effort at the main brake, is therefore proportional to the torque applied at the control brake. Furthermore the braking torque generated by the moving disc 27 is carried back to the hub 25 via the ball spline 29/30/31 and so does not affect the ball screw and the braking effort, so there is no tendency for the brake to lock or jam as it is applied.

It will also be appreciated that the brake assembly is self-energising, in the sense that the braking force is derived from the movement of the vehicle itself, and no additional servo-assistance is required for effective brake actuation. By way of example, in the case of a brake assembly as described above, even when provided for braking a respective drive shaft to the track on one side of a heavy (armoured) military vehicle transmission, the force to operate the control brake may only need to similar to that for a typical motor cycle brake and can be applied by the driver's effort eg through a cable or simple hydraulic master cylinder without further assistance.

For operation as a parking brake, an additional user-operated calliper may be provided to operate on the control disc 13. The degree of “roll-back” of the vehicle that may be permitted by such a brake, if parking on a slope for example, is however minimal due to the coarse pitch of the ball screw 32 and the gear reduction provided by the final drives 5a,5b between the respective shaft 3a,3b and track drive sprocket 6a,6b.

Although described above in relation to a brake assembly, the assembly of ball screw 32, control brake disc 13 and thrust bearing 33, which results in equivalent axial motion of the shiftable disc 27 irrespective of the direction of relative angular displacement of the control brake disc, constitutes an example of a rotary-to-linear motion actuator that could be useful in various other applications, and represents an independent aspect of the present invention.

1. A brake assembly for a rotatable member comprising: a rotary disc member borne by said rotatable member to rotate with the same but capable of moving axially relative to the same into frictional contact with an associated non-rotatable disc member to brake said rotatable member; a control brake member borne by said rotatable member to rotate with the same but capable of turning relative to the same; a screw assembly between said control brake member and said rotary disc member; and means for selectively retarding the rotation of said control brake member relative to said rotatable member whereby to cause said screw assembly to shift said rotary disc member axially into said frictional contact with said non-rotatable disc member.

2. A brake assembly according to claim 1 wherein said rotary disc member carries friction material for contact with said non-rotatable disc member.

3. A brake assembly according to claim 1 comprising a second rotary disc member borne by said rotatable member to rotate with the same and disposed on the opposite side of said non-rotatable disc member to the first-mentioned rotary disc member, whereby axial movement of the first-mentioned rotary disc member is effective to clamp the non-rotatable disc member between the two rotary disc members.

4. A brake assembly according to claim 1 wherein said non-rotatable disc member is adapted to be cooled by the circulation of liquid through an internal chamber of such member.

5. A brake assembly according to claim 1 wherein said screw assembly comprises a ball screw assembly.

6. A brake assembly according to claim 5 wherein said ball screw assembly comprises radially inner and outer screw rings with a plurality of balls therebetween, one of said rings is arranged to rotate with said rotatable member but capable of moving axially relative thereto, and the other of said rings is arranged to rotate with said control brake member but capable of moving axially relative thereto.

7. A brake assembly according to claim 1 wherein said screw assembly is abutted between a pair of thrust bearings, a first such bearing is borne by said rotatable member to rotate with the same without freedom to move axially relative to the same, and the second such bearing is abutted between the screw assembly and the first-mentioned rotary disc member and serves to transmit axial movement from the screw assembly to such disc member.

8. A brake assembly according to claim 1 wherein said control brake member comprises a disc or drum and said retarding means comprises friction material for contact therewith.

9. A vehicle equipped with one or more brake assemblies according to claim 1.

10. A skid steered vehicle having a transverse drive configuration comprising respective drive shafts for transmitting torque to traction elements on opposite sides of the vehicle, and comprising respective brake assemblies according to claim 1 for braking respective said shafts.

11. A rotary-to-linear actuator comprising: first and second members borne for relative rotational movement therebetween over a certain range in opposite senses from a central position; a screw assembly comprising outer and inner threaded members; said outer threaded member being rotationally located with respect to said first member but capable of moving axially relative thereto; said inner threaded member being rotationally located with respect to said second member but capable of moving axially relative thereto; and abutment means at one axial end of said screw assembly which are axially located with respect to said first and second members; all constructed and arranged such that: relative rotational movement between said first and second members in one sense away from said central position causes said outer threaded member to be in abutment with said abutment means while said inner threaded member is driven axially away from said abutment means in a predetermined sense; and relative rotational movement between said first and second members in the other sense away from said central position causes said inner threaded member to be in abutment with said abutment means while said outer threaded member is driven axially away from said abutment means in the same said predetermined sense.
